(19) United States
(12) Patent Application Publication
(10) Pub. No.: US 2023/0148566 A1
(43) Pub. Date: May 18, 2023

(54) PROLONGED INGESTION APPARATUS AND METHOD AND SYSTEM FOR USE

(71) Applicant: COOLHOUSE SOURCING LLC, Minneapolis, MN (US)

(72) Inventors: Andrew UBEL, St. Paul, MN (US); Lee Wayne MAYBERRY, Arvada, CO (US)

(21) Appl. No.: 17/971,478

(22) Filed: Oct. 21, 2022

Related U.S. Application Data
(63) Continuation of application No. PCT/US2021/028311, filed on Apr. 21, 2021.
(60) Provisional application No. 63/013,108, filed on Apr. 21, 2020.

(51) Int. Cl. A01K 15/02; A23K 10/30

(52) U.S. Cl. CPC A01K 15/025; A23K 10/30

(57) ABSTRACT

A chew resistant dog toy securely contains and retains a replaceable lickable treat. The toy facilitates the predictable, gradual, and prolonged ingestion of the treat by an animal's licking of an available surface of the lickable treat. The dog toy has a chew resistant body (typically made of a tough polymer or a hard rubber material) and a channel having an elongated opening along a major surface of the toy. The channel is adapted to receive and securely hold and retain the treat. The treat may or may not contain one or more active ingredients that are useful for promoting a calming effect on the dog, including active agents (such as theanine, Relora, SAMe, GABA, ashwagandha, tryptophan, turmeric, Boswellia serrata, panax ginseng, Methylsulfonylmethane, 5-HTP, etc.), other botanicals that facilitate sleep and relaxation (such as Valerian root, Chamomile, Lemon balm, Passion flower, Kavakava, Tulsi-Holy basil (Ocimum tenuiflorum)) and cannabinoids (such as CBD, CBN, etc.).

### CROSS REFERENCE TO RELATED APPLICATIONS

This application is a continuation under 35 U.S.C. § 111 of International Application No. PCT/US2021/028311 filed Apr. 21, 2021, which claims priority under 35 U.S.C. § 119 to U.S. Provisional Application No. 63/013,108 filed Apr. 21, 2020, the disclosures of both of which are incorporated herein by reference.

### BACKGROUND

Companion animals are often given toys or other devices to keep them interested or occupied. The devices can contain a variety of active or passive stimuli to keep the animals interested in the device. For example, a dog toy might have a squeaker embedded in the device that emits a noise when the dog steps on or bites down on the device. This noise can cause the dog to play with the device for a longer period of time than a similar device without the noise emitter. The stimuli can be mechanical, organoleptic, tactile (e.g., bumpy surfaces that massage the animal's mouth), electronic (noise, vibration), etc. Particularly effective occupying toys contain an edible and tasty treat.

One popular type of “occupying” device for dogs contains an embedded treat. An example of such a device is the KONG™ Classic device from the Kong Company. See https://kongcompany.com/kong-classic. Typically, the dog's owner “stuffs” a large cavity of the rubber device with kibble, peanut butter or another ingestible treat or paste, and the dog shakes, rattles, bites, moves or otherwise uses the device to dislodge the treat from the device. Unfortunately, these devices do not reliably facilitate the predictable, gradual, or prolonged ingestion of the treat by a dog.

For example, some devices, like the Kong device, have openings to accept and then loosely lodge the treat inside of the device. But the typical mechanisms for containing the treats inside the device can be easily defeated by the dog. For example, dogs quickly learn that shaking, dropping, or throwing the device may dislodge all or a tuggable part of the treat(s) from the device, thereby enabling the dog to devour the entire treat with a few quick bites. If, however, the treat is buried deeply in the toy and is not dislodgeable (for example, a small lump of peanut butter stuck in the bottom of a Kong toy), the treat may remain trapped inside the toy and not accessible by licking. As a result, the dog either gets frustrated (and more agitated) or simply loses interest in the device. Regardless of whether the treat is too easy or too hard to remove, the dog may become quite active when using these types of devices. They learn to throw, shake or toss the devices and this type of active usage is not a calming activity for the animal.

Another product on the market is sold under the name NYLABONE™ Romp 'n Chomp Super Treat Holder Dog Chew Toy by Nylabone, see www.nylabone.com/products/product-type/treat-toys/romp-n-chomp-treat-holder-and-treat. This treat holder is designed with a rectangular groove along one side of the device. The groove (with a slightly open tapered square profile) is adapted to receive a somewhat hard treat that loosely “snaps” into the groove. This design has the advantage that the treat is positioned to be easily lickable by the dog. While licking the treat should be a fairly reliable way to prolong the ingestion of a treat, the treat in the Nylabone device is only loosely held in place in the groove by two rigid tabs at the midpoint of the device. Unfortunately, a dog can easily learn to dislodge the treat from the device by dropping the loaded device onto the floor. Once dislodged, the treat then can be quickly devoured by the dog. Consequently, this toy is not an acceptable way to reliably prolong the ingestion period of the treat.

### SUMMARY

The toys discussed above include treats without active ingredients and where a prolonged and reliable ingestion period of a treat (or more importantly an active ingredient contained therein) is not critical. Moreover, the above devices do not reliably provide a prolonged ingestion period that calmly occupies a dog. Rather, they induce activity in the dog as it tries to knock the treat(s) free of the device for quick ingestion or lick an inaccessible treat buried deep in the device. From the foregoing, it will be appreciated that what is needed in the art is a device that can hold a treat and that facilitates the predictable, gradual, or prolonged ingestion of the treat by a dog through licking. Such apparatuses, systems or methods are disclosed and claimed herein.

Various aspects of the instant disclosure are directed to apparatuses, systems or methods that facilitate the prolonged ingestion of a treat (preferably containing an active ingredient) into a dog. As will be apparent from the more detailed discussion that follows, one or more these aspects are directed to overcoming issues including but not limited to those mentioned above.

In some aspects, the disclosure is directed to a chew resistant article (preferably a dog toy) that contains and retains a replaceable treat in a secure, lickable manner. The article facilitates the predictable, gradual, and prolonged ingestion of the treat by an animal's licking of an available surface of the treat.

In some embodiments, the dog toy has a chew resistant body (typically made of a nylon or similarly tough moldable thermoplastic or thermoset polymer, or of a hard rubber material) having a first end, a central portion and a second end. The toy further includes a channel along at least a portion of the toy, wherein the channel has an elongated opening along a major surface of the toy. The channel is adapted to receive and securely hold and retain a replaceable treat so that a substantial portion (e.g., at least one-third, preferably at least one-half and more preferably at least two-thirds) of the treat will be consumed by licking.

In some embodiments the toy is formed of two major pieces that when separated (or alternatively rotated relative to each other) permit the treat to be slid into the channel from the end of the channel. The treat is sized to fit into the channel from an openable end of the channel and the channel is designed to have one or more undercuts or other retaining devices that prevent the treat from easily being dislodged, removed or consumed (other than by licking) though the elongated opening. In one preferred embodiment, the article comprises two pieces that may be connected using a closure that requires two dissimilar motions for opening.

In some embodiments the toy is formed of one major piece and a separable plug that when separated permit the treat to be slid into the channel from an opening at the end of the channel. The treat is sized to fit into the channel from an openable end of the channel and the channel is designed to have one or more undercuts that prevent the treat from easily being dislodged, removed or consumed (other than by licking) though the elongated opening. When in place the plug prevents the treat from falling out of the channel from the end. In one preferred embodiment, the plug may be connected to the major piece using a closure that requires two dissimilar motions for opening.

In some embodiments the toy is formed of one major piece that permits the treat to be slid or pressed into the channel through an open end of the channel. In some embodiments the treat is sized to fit into the channel through the open end, and the channel is designed to have one or more undercuts, plugs, doors, flexible hooks, flaps or other retaining devices that enable retention of the treat (viz., prevention from sliding back out of the end opening or the channel) when the toy is subjected to the “Drop Test” described below. In some embodiments a retaining device may not be needed, and the treat may be formulated or sized to fit into the channel through the open end sufficiently snugly to enable retention of the treat in the toy when the toy is subjected to the Drop Test. Such formulation or sizing may for example include increasing the stickiness of the treat or its tendency to swell when exposed to air or moisture, increasing the width or height of the treat with respect to the channel so that the treat has to deform slightly to fit into the channel, providing the treat with a slight bowing along the long axis so that the treat has to deform slightly to fit into the channel, providing the treat with a slight twist to its shape so that the treat has to deform slightly to fit into the channel, or combinations thereof. The channel opening and depth may also be designed to prevent a substantial portion (e.g., at least one-third, preferably at least one-half and more preferably at least two-thirds) of the treat from easily being consumed other than by licking the treat through the elongated opening. Alternatively or in addition, the treat may be profiled such that it can be slid into the end opening (like a key into a lock) and then rotated once in the channel to prevent removal through the same opening. In some embodiments the treat is too big to be dislodged through the large major surface opening (the “licking opening”) through which the treat is licked by the dog.

In some embodiments the toy has an elongated channel adapted to receive a treat via the major surface opening. The channel may include one or more buttons, hooks or other retaining devices including those mentioned above that are pushed out of the way when the treat is introduced into the channel via the major opening, but which then move back (e.g., snap back) to lock the treat into place and prevent the treat from being dislodged from the toy. When the toy is constructed of a generally rigid polymer (such as a nylon material) the retaining devices may for example be injection molded hooks on the ends of long thin protrusions that can be bent out of the way of the channel without causing undue damage to the treat. When the toy is constructed out of a hard rubbery material (such as is employed by the Kong company) the hooks or retention flaps are preferably molded into the toy such that the channel wall itself can deform when the treat is pressed into place and then rebound back to “partially close” the opening so as to securely retain the treat in the channel. In this embodiment it is preferred that the treat closely fit the channel size underneath the retaining devices.

The above summary of the disclosed device is not intended to describe each disclosed embodiment or every implementation of the present invention. The description that follows more particularly exemplifies illustrative embodiments.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWING

FIG. 1 illustrates a Prior Art dog bone toy that inadequately retains an extruded treat.

FIGS. 2A-E illustrate embodiments of a two-piece dog bone toy that securely contains and retains a lickable treat.

FIGS. 3A-D illustrate alternative embodiments of a two-piece dog bone toy that securely contains and retains a lickable treat.

FIG. 4 illustrates an alternative embodiment of a dog bone toy that securely contains and retains a lickable treat.

FIGS. 5A and 5B-D illustrate an alternative embodiment of a dog bone toy that securely contains and retains a lickable treat, with FIG. 5A being a top view of the toy and FIGS. 5B-D being three time lapse cross-sectional views showing a treat being inserted in the toy.

FIGS. 6A-C illustrate alternative embodiments of a rubber dog bone toys that securely contains and retains a lickable treat, with FIG. 6A being a top view of the toy and

FIGS. 6B-C showing alternative cross-sectional views of the toy's channel along line A-A.

FIGS. 7A-C illustrate an alternative embodiment of a two-piece dog bone toy that securely contains a lickable treat, with FIG. 7A being a top view of the two-piece toy (separated) and FIGS. 7B and 7C being Side A and Side B views showing a passthrough channel along Side B.

FIG. 8 and FIGS. 8A-C illustrate a profiled treat (FIG. 8C) and the profiled treat as inserted in the toy with a first position (FIG. 8A) where the treat profile is matched to a feature on the end of the toy and a second position (FIG. 8B) where the treat has been rotated so the treat profile is captured by the toy and cannot be easily removed through the open end.

FIG. 9 illustrates an alternative embodiment of a two-piece dog bone toy that securely contains and retains a lickable treat.

FIGS. 10A-B illustrate an alternative embodiment of a rigid dog bone toy that securely contains a flexible lickable treat, with FIG. 10A being a top view of the toy and FIG. 10B showing a cross-sectional view of the toy's channel along line A-A.

FIGS. 11A-H illustrate another embodiment of a rigid dog bone toy that securely contains a flexible lickable treat.

### DETAILED DESCRIPTION

Unless otherwise specified, the following terms as used herein have the meanings provided below.

Terms such as “a,” “an,” “the,” “at least one,” and “one or more” are used interchangeably. Thus, for example, a composition that comprises “an” ingredient can be interpreted to mean that the composition includes “one or more” ingredients.

The term “active ingredient” when used in connection with a chemical in a lickable treat administered to or to be administered to an animal means that such chemical is bioactive in such animal.

The terms “comprises,” “includes” and variations thereof do not have a limiting meaning where these terms appear in the description and claims.

The term “extract” or “ground portion” when used in connection with a medicinal plant, tree bark or root refers to a chemical or mixture of chemicals obtained from such plant by any suitable purification or concentration technique (e.g., by expression, absorption, maceration or distillation), and shall also include a synthesized (including fermented or otherwise biosynthesized) chemical or mixture of chemicals having the same or substantially pharmacologically equivalent structures.

The term “non-prescription” when used in connection with an active ingredient administered to or to be administered to an animal means an active ingredient whose purchase or use do not require a prescription from a licensed veterinarian in the applicable jurisdiction where such administration occurs or will occur.

The term “non-psychoactive” when used in connection with an active ingredient administered to or to be administered to an animal means that the ingredient does not produce a significant effect (such as changes in perception or behavior) on the mind or mental processes of such animal. By way of example, a person having ordinary skill in the art would regard CBD as non-psychoactive and THC as psychoactive.

The term “over-the-counter cold remedies” refers to a non-prescription retail product whose primary labelled use is for the treatment of the common cold symptoms.

The term “over-the-counter allergy treatments” refers to a non-prescription retail product whose primary labelled use is for the treatment of allergy symptoms.

The term “pharmacologically active” when used in connection with an active ingredient administered to or to be administered to an animal means that such chemical has beneficial bioactive effects.

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the invention.

In one embodiment, the disclosed system and method includes a chew resistant dog toy that securely contains a dog treat. Exemplary such toys may be injection molded (e.g., out of a tough polymer such as a nylon or out of a hard rubber material). Preferably the dog treat is securely contained and retained in the toy in a manner that facilitates the dog licking a major surface of the dog treat while preventing or discouraging the dog from using other measures to remove and quickly consume the treat.

By “securely contained and retained” is meant that the treat, though being available for licking by the dog, cannot easily be dislodged from the toy by dropping. Preferably the treat cannot easily be dislodged until at least one-third, more preferably at least one-half and most preferably at least two-thirds of the treat has been licked away.

The disclosed dog toy serves as a tasty and engaging “occupying toy” for dogs. By presenting a tasty dog treat in a lickable position, the toy facilitates prolonged ingestion of the treat and prolonged activity by the dog. The dogs preferably “keeps at” the toy for a prolonged period and keeps licking until the entire treat is consumed. Moreover, because the treat is secured within the toy and not removable by the dog via shaking or dropping the dog is not conditioned to be violent with the toy and instead calmly licks the toy without the dropping, shaking and throwing activity.

In one embodiment, the dog toy has a chew resistant body (typically made of a nylon polymer) having a first end, a central portion and a second end. The toy further includes a channel along at least a portion of the toy, wherein the channel has an elongated opening along a major surface of the toy. The channel is adapted to receive a treat and to securely hold and retain the treat in a lickable position in the channel.

In one embodiment the toy is formed of two major pieces that when separated or rotated relative to each other permit the treat to be slid into the channel from the end of the channel. The treat is sized to fit into the channel from an open end of the channel and the channel has one or more undercuts or other retaining devices that prevent the treat from easily being dislodged though the major opening.

In another embodiment the toy is formed of one major piece that permit the treat to be slid into the channel from the end of the channel. The treat is sized to fit into the channel from an open end of the channel. The channel may have one or more undercuts or other retaining devices that prevent the treat from easily being dislodged, removed or consumed (other than by licking) though the major opening. The treat is slid into the channel and may be retained (for example, when the toy is subjected to the Drop Test) by using retaining devices such as plugs, doors, flexible hooks or flaps on the toy. In some embodiments a retaining device may not be needed, and the treat may be formulated or sized to fit into the channel sufficiently snugly to enable retention of the treat in the toy when the toy is subjected to the Drop Test. Such formulation or sizing may for example include increasing the stickiness of the treat or its tendency to swell when exposed to air or moisture, increasing the width or height of the treat with respect to the channel so that the treat has to deform slightly to fit into the channel, providing the treat with a slight bowing along the long axis so that the treat has to deform slightly to fit into the channel, providing the treat with a slight twist to its shape so that the treat has to deform slightly to fit into the channel, or combinations thereof. The channel opening and depth may also be designed to prevent a substantial portion (e.g., at least one-third, preferably at least one-half and more preferably at least two-thirds) of the treat from easily being consumed other than by licking the treat through the elongated opening. Alternatively or in addition, the treat may be profiled such that it can be slid into the end opening (like a key into a lock) and then rotated once in the channel to prevent removal through the same opening. In some embodiments the treat is too big to be dislodged through the large major surface opening (the “licking opening”) through which the treat is licked by the dog.

In some embodiments the toy has an elongated channel adapted to receive a treat via the major surface opening. In some embodiments, the channel may be configured with one or more buttons or hooks (or other such retaining devices) that are pushed out of the way when the treat is introduced into the channel via the major opening, but which then move (e.g., snap) back sufficiently to lock the treat into place and prevent the treat from being dislodged from the toy. In some embodiments, the treat may be formulated or sized so that it is snugly retained in the toy when inserted into the toy via the major surface opening.

Licking the treat preferably takes quite a long time (up to several hours) and serves to reliably occupy the dog. In contrast, regular nylon toys that do not include a treat are not as reliably engaging for the dog (viz., the dog can lose interest in the toy after a few minutes). Also in contrast, prior art nylon toys like the Nylabone product do not adequately secure its treat. As a result, the toy can be easily defeated by the dog and the treat consumed within minutes. In such cases the toy then becomes an ordinary nylon toy that does not engage the prolonged ongoing activity of the dog. In essence, the dog oftentimes simply loses interest in the Nylabone toy once the treat is successfully dislodged and consumed.

In preferred embodiments the treat is made using a composition that when licked by a dog releases enough taste to maintain the dog's interest, but which requires a lot of licking to be consumed. Treats that are too soft or too soluble in saliva can be licked away too quickly. Preferred treats can be licked aggressively over a period of at least one hour, more preferably at least two hours, and optimally at least three hours.

In preferred embodiments the dog treat is made using a tasty composition that interests the dog and entices it to consume the treat by licking notwithstanding the lengthy time that may be required.

Exemplary treats for use in the disclosed device include extruded or molded treats that are sized to fit in the channel and be retained therein until licked out. By altering the softness or hardness of the treat, the time required for the dog to consume the treat by licking can be adjusted to last for a few minutes, an hour, several hours (e.g., two, three, four or more hours) or a day. Preferred treats are semi-hard, though not necessarily as hard as a hard candy, lickable by a dog without dissolving or breaking down too quickly (e.g., lasting for at least 30 minutes and more preferably for at least one hour or at least two hours), resistant to breakage if accidentally dropped by the dog owner during loading, and tasty to a majority of dogs. By “semi-hard” is also meant a treat that can be extruded or molded into a shape and retain that shape when being inserted into a channel of the disclosed device.

The treat should survive multiple licks by the dog to provide the prolonged ingestion of the treat's ingredients. Exemplary treats are sufficiently hard (or compacted) such that the treat generally retains its shape (other than the gradual and desirable removal of the licked surface material) when licked by a one year old Labrador retriever dog for at least 20 licks, more preferably at least 50 licks, most preferably at least 100 licks, and optimally at least 300 licks. Exemplary treats can have a range of hardnesses, for example like those of a medium hard human candy like STARBURST™ taffy, or the outer layer of a TOOTSIE-ROLL™ pop, or a much harder human candy such as JOLLY RANCHER™ hard candy. When used with toys that have rigid retaining devices, exemplary treats are preferably compliant and elastic like a human candy like GUMMY BEARS™.

In preferred embodiments the treats are profiled to match the channel's cross-sectional shape and any retaining devices. For example, if the channel has sloped inward sidewalls, then the treat preferably has similarly sloped sides. In some embodiments the treat will have indents or notches that accept a movable retaining device of the article.

In some embodiments a plurality of toys sized to accommodate different sized dogs (e.g., small, medium and large dogs) may be produced with a treat-receiving channel having the same cross-sectional shape and size for each size toy, and with an increasing channel length for each respective toy size. In that way a single extrusion die may be used to produce the corresponding treats, with the treat lengths being cut to appropriate lengths for each desired toy size.

In some embodiments a plurality of toys sized to accommodate different sized dogs may be produced with a treat-receiving channel having the same cross-sectional shape and size for each size toy, and with a channel length for the larger sizes that is an integer multiple of the channel length for the smallest toy size. In that way treats having the same cross-sectional shape, size and treat length may be produced, with a single treat being used in the smallest toy size and two or more such treats being concatenated end-to-end in the larger toy size(s).

When used as an occupying toy, the treat may or may not contain one or more active ingredients that are useful for promoting a calming effect on the dog, including ingredients such as are described in copending U. S. Provisional. Application No. 63/13,158 filed Apr. 21, 2020 and in copending International Application No. PCT/US2021/028302 filed Apr. 21, 2021, both of which are entitled COMPOSITION, ARTICLE AND METHOD FOR AFFECTING A MAMMAL and both of which are incorporated herein by reference.

More preferred treats include one or more active ingredients for calming or otherwise treating or affecting the dog. Exemplary active ingredients include active agents (such as theanine, Relora, SAMe, GABA, ashwagandha, tryptophan, turmeric, Boswellia serrata, panax ginseng, Methylsulfonylmethane, 5-HTP, etc.), other botanicals that facilitate sleep and relaxation (such as Valerian root, Chamomile, Lemon balm, Passion flower, Kavakava, Tulsi-Holy basil (Ocimum tenuiflorum)) and cannabinoids (such as CBD, CBN, etc.). Exemplary dosages of such active ingredients are further described in the aforementioned patent application.

Exemplary active agents for use in the disclosed device include:
amino acid-based ingredients that have central nervous system effects;
receptor modulators for acetylcholinesterase, butyrylcholinesterase, 5-HT1 or 5-HT2;
monoamine metabolizers;
extracts of certain medicinal plants, tree barks and roots; and
other pharmacologically active chemicals and agents.

Exemplary cannabinoids for use in the disclosed device include pharmacologically active, but preferably non-psychoactive, cannabinoids. Presently preferred cannabinoids include cannabidiol (CBD), cannabinol (CBN), cannabigerol (CBG), cannabichromene (CBC), cannabielsoin (CBE), cannabicyclol (CBL), cannabicitran (CBT), cannabichromanone (CBCN), cannabinodiol (CBND) and related compounds. Presently most preferred cannabinoids include CBD, CBN and CBG.

Exemplary treats are sized to meet the needs of different sized dogs. It is common to prepare suitable dosages for small dogs (5 to 25 pounds; 2.3 to 11.3 kg), medium dogs (26 to 50 pounds; 11.8 to 22.7 kg) and large dogs (51 to 100 pounds; 23.1 to 45.4 kg). Typically, the dosage of an ingredient will target the midpoint of the lower and upper ends of the weights for the particular size of dog. For example, a medium sized dog has an 11.8 to 22.7 kg size range, with a midpoint of 17.2 kg. When expressing suitable and preferred dosages of an ingredient in this document, it will generally be done as a mg/kg figure.

If provided with one or more active ingredients, the ingredients are provided in the treat such that the dosage of the ingredient is appropriate for the sized dog using the toy. Typical and exemplary dosages of active ingredients are described in the aforementioned co-pending U. S. Pat. Application.

Typical optimal dosages of various active ingredients are listed in Table 1 below for typical small, medium and large dogs. It is understood that these dosages are approximate and can be adjusted as needed. The disclosed toys can include one or more of the active ingredients. Mixtures of two or more such ingredients are preferred as is discussed in the co-pending patent application.

TABLE 1

| | Small dog | Med. Dog | Large dog |
|---|---|---|---|
| Ingredient | mg | mg | mg |
| Broad spectrum hemp extract | 6 | 14 | 28 |
| CBD | 4 | 10 | 20 |
| CBN | 2 | 4 | 8 |
| CBG | 2 | 4 | 8 |
| Relora | 69 | 175 | 345 |
| SAMe | 79 | 200 | 395 |
| Trytophan | 71 | 181 | 357 |
| GABA | 39 | 100 | 197 |
| Theanine | 20 | 50 | 99 |
| Ashwagandha | 12 | 30 | 59 |
| Turmeric | 143 | 362 | 714 |
| Boswellia serrata | 41 | 103 | 204 |
| Methylsulfonylmethane | 49 | 123 | 243 |
| Panax ginseng | 29 | 74 | 146 |
| 5-HTP | 32 | 80 | 158 |

Preferred dosages are from 20 to 300%, more preferably from 35 to 200%, and most preferably from 50 to 150% of the optimal dose.

When used to treat a particular issue (e.g., separation anxiety), it may be desirable to administer a first dosage of the active ingredients in a bolus (such as from a soft chew, melt or topper) and then provide the dog with a second dosage that can be consumed over a prolonged period by the dog's consumption of the disclosed toy. In the case of a separation anxiety treatment, the first dose will act to quickly calm the dog, while the toy (and included second dosage) will continue and prolong the calming effect.

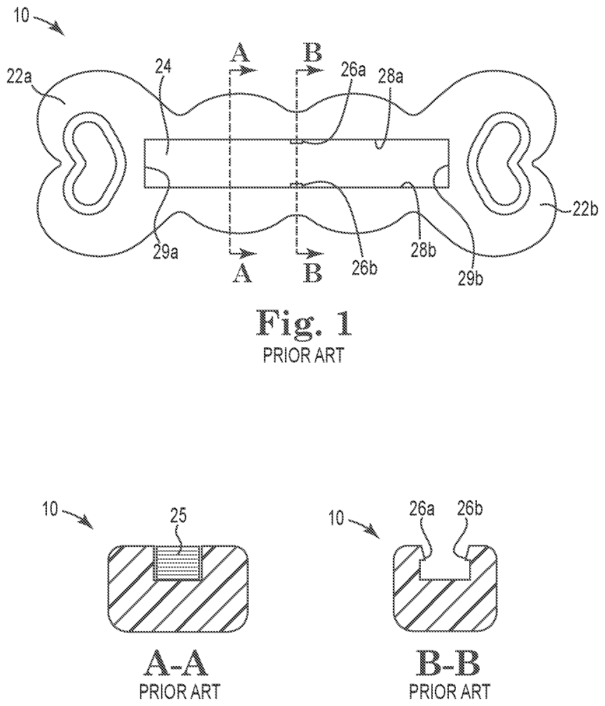

FIG. 1 illustrates a Prior Art dog bone toy 10 that contains but does not adequately retain an extruded treat 25. The device has two knobby ends 22a and 22b and a central portion between the knobby ends. The central portion contains a long channel 24 having two long sides 28a and 28b and two ends 29a and 29b. Channel 24 has a rectangular opening as shown in the top view and a generally square profile as shown in View A-A. Channel 24 has a slightly smaller bottom width across section A-A than near the opening. This small draft facilitates injection molding of the toy.

As shown in the top view and in View B-B, two small protrusions 26a and 26b (tabs) are present at the midpoint of channel 24. Notably, tabs 26a and 26b are made of the same rigid nylon material as toy 10 and the tabs and the sides of channel 24 do not deform out of the way when a treat is inserted. Rather, the provided treat is “forced” past tabs 26a and 26b to purportedly “lock” the treat into place. Because tabs 26a and 26b do not yield, the treat becomes distorted (e.g., grooved) as it moves past tabs 26a and 26b). Also, toy 10 attempts to secure only the middle and not the ends of the treat in the channel. Unfortunately, this design is largely ineffective to secure the treat in the toy. A dog can for example simply toss the toy in the air and allow it to fall on or against a hard surface to cause the treat to dislodge or tuggably project from the toy. As a result, the dog's owner has no expectation that the treat will be securely held in a lickable position. Consequently, this design is ineffective as a prolonged occupying toy. It is also ineffective as a device to facilitate the ingestion of the treat over a reliably prolonged period.

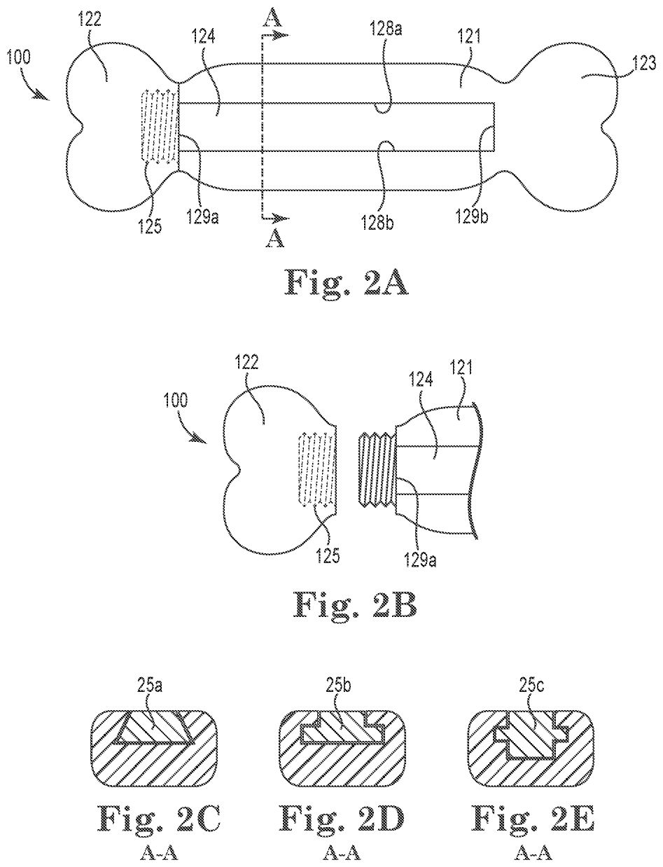

FIG. 2A, partial view FIG. 2B and the alternative cross-sectional views of FIGS. 2C, 2D, and 2E illustrate embodiments of a dog bone toy 100 that securely contains and retains a lickable treat such as lickable treat 25a (shown in cross-section in FIG. 2C), lickable treat 25b (shown in cross-section in FIG. 2D) or lickable treat 25c (shown in cross-section in FIG. 2E). The toy 100 has a general bone shape, though this is not critical to the device's performance and other shapes such as antlers, horns, geometric shapes, etc., may be used. In the embodiments shown, the device has a central portion 121 between two knobby ends 122 and 123. The knobby ends 122, 123 facilitate the dog holding toy 100 when it is being licked. The central portion 121 contains a long channel 124 having two long sides 128a and 128b and two ends 129a and 129b. Channel 124 has a rectangular opening as shown in the FIG. 2A top view and has a profile with undercuts along an appreciable portion of the length of the channel 124 (for example, at least 10%, at least 20%, at least 30%, at least 40% or at least 50% of the channel 124 length). The undercuts can be of virtually any shape provided that the undercuts secure the treat against falling out of the channel via the opening. Several exemplary undercut profiles are shown in FIGS. 2C, 2D, and 2E. Providing an undercut can be accomplished in several different ways. For example, undercuts can be provided in an injection molded part by manufacturing the injection molding tool with “slides.” The slides are retracted when it is desired to extract the injection molded part from the tool. Alternatively, a channel without an undercut (viz., a channel whose sidewalls are like those shown at Section A-A in FIG. 1) can be provided when the toy is molded and a secondary operation (such as a machining operation) can be used to add an undercut to the channel. For example, a typical sloped “dovetail” routing bit can be used to provide a side profile such as is shown in cross-sectional view of FIG. 2C. Other tool profiles can be used to provide other exemplary undercuts as shown in cross-sectional views of FIGS. 2D and 2E.

As depicted, the toy 100 of FIG. 2A and FIG. 2B is made of two separable pieces. In one embodiment, knobby end 122 is separable from the rest of toy 100. As shown in FIG. 2B, the pieces may be separated by unscrewing knobby end 122 from central portion 121 (the female thread 125 for which is illustrated in phantom in FIG. 2A and FIG. 2B). The end 129a of channel 124 is thereby removed with knobby end 122 and an open end of channel 124 is exposed. This permits the sliding of a new treat into the channel 124 from the now open channel end. Once the knobby end 122 is screwed back onto the central portion 121 the treat is effectively and securely “captured” in the toy and the channel undercuts prevent the sudden removal of the treat from the toy's long lickable opening by the dog. Notably, the treat is still lickable by the dog, but due to the undercuts the fresh treat is simply too big to fall out of the toy's opening. As the licking progresses the treat may at some point become small enough to be removed by the dog. However, by properly designing the shape of the undercut the unwanted removal can be delayed until the dog has had to lick at least one-third, more preferably at least one-half, and most preferably at least two thirds of the treat. This ensures that the toy 100 will provide a prolonged occupying period and, in the case where the treat contains an active ingredient, a prolonged ingestion period for the active ingredient.

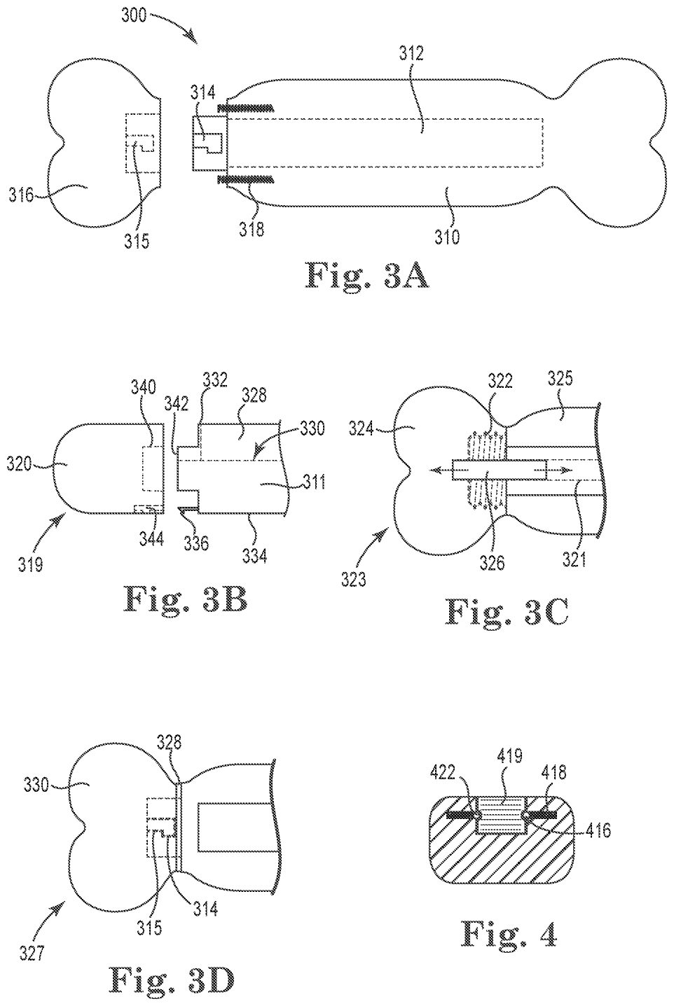

FIG. 3A illustrates a toy 300 where knobby end 316 is held onto the remainder of toy 300 using one or more bayonet lugs 315 and mating socket 314 that resist the removal of knobby end 316 from unless the knobby end 316 and the remainder of toy 300 are pushed together and simultaneously twisted to move the knobby end into an “unlocked” position. One or more springs 318 may be used to keep the lugs in the locked position, viz., by pushing the knobby end away from the central portion and thereby tightly engaging the lugs in the locked position. The human user would need to push the two pieces together (viz., pushing against the springs) while at the same time twisting the knobby end relative to the central portion. This two-way action is analogous to the techniques used to “child-proof” a pill bottle and other suitable “child-resistant” closing methods can be used if desired. The toy 310 of FIG. 3A preferably has a channel 312 for receiving a treat as is described in FIG. 2. As will be appreciated, the connecting portions can be reversed, and the springs and lugs disposed in the opposite piece to that which is illustrated.

FIG. 3B illustrates a side view of a toy 319 where knobby end 320 is held in place using one or more hooks (or other retaining devices such as buttons) 336 that resist the removal of knobby end 320 from central portion 311 unless the one or more hooks 336 is pushed in while knobby end 320 is simultaneously pulled off portion 311. The hooks(s) can be spring loaded or otherwise cantilevered so that the ends of the hook(s) are normally engaged with a corresponding mating hole or other receptacle 344 in the sidewall of knobby end 320. As depicted, the hook(s) must be pushed towards the central axis of toy 319 to disengage the hook(s) and knobby end 320. Alternatively (not shown) the one or more buttons (or hooks) can be part of the knobby end and the mating hole or other receptacle can be disposed in central portion 311. Again, the human user would need to simultaneously complete two actions (viz., pushing the hook and pulling the pieces apart) to actually separate the pieces. The toy 319 of FIG. 3B has a channel 328 for receiving a treat as is described in FIG. 2, a bottom surface 334 and an upper surface 332. The separated knobby end 320 also has a receiver 340 that mates with a projecting portion 342 on central portion 311.

FIG. 3C illustrates a toy 323 where knobby end 324 is held onto central portion 325 using a screw thread 322 like that shown in FIG. 2B, with the exception that the toy of FIG. 3C further comprises a mechanism to prevent the dog from untwisting knobby end 324 from the central portion 325. In one embodiment, toy 323 is provided with a sliding locking bar 326 that can be positioned in a first position wherein a portion of locking bar 326 remains in knobby end 324 and the remainder of locking bar 326 protrudes into a groove 321 (shown in phantom) in central portion 325. When so engaged, locking bar 326 prevents the untwisting of knobby end 324. Locking bar 326 can be retracted to a second position (not shown in FIG. 3C) in knobby end 324 wherein bar 326 no longer protrudes into groove 321. In this second position knobby end 324 can be untwisted from toy 323. Preferably locking bar 326 has a mechanism (not shown in FIG. 3C) to resist unwanted sliding of bar 326 from its first position.

FIG. 3D illustrates a toy 327 that operates in a manner similar to the toy of FIG. 3A. In place of the spring(s) illustrated in FIG. 3A, the toy of FIG. 3D uses a compressible gasket 328 to provide a force that separates the knobby end 330 from the remainder of toy 327 and thereby helps engage the locking lugs 314 in socket 315.

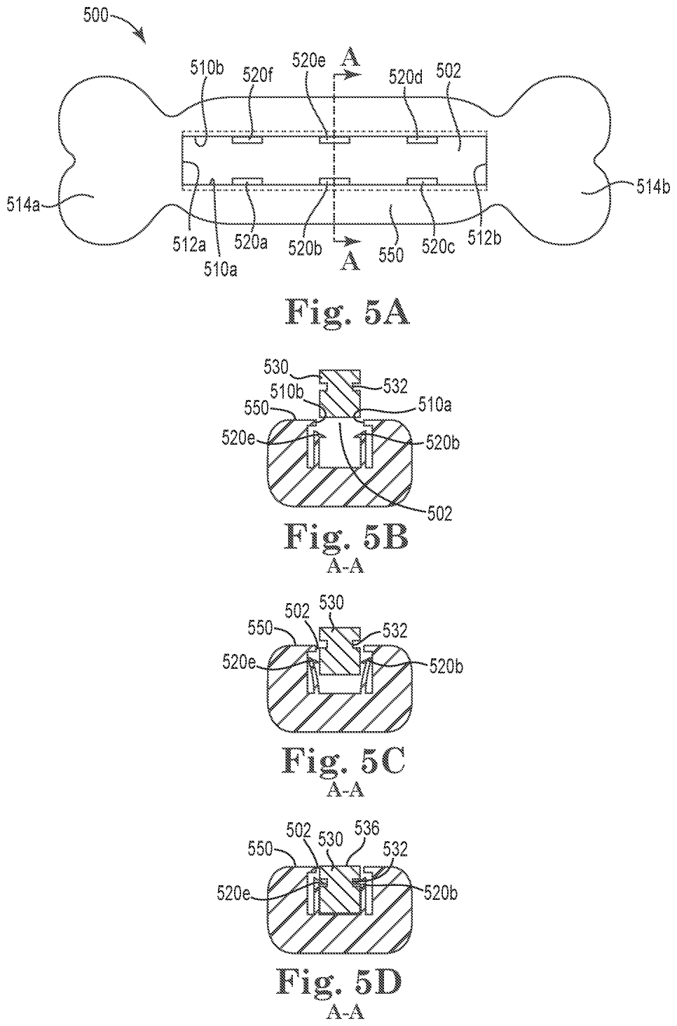

FIG. 4 illustrates a toy where the rigid “tabs” of the prior art are replaced with one or more (and preferably two, three, four or more) spring loaded balls. FIG. 4 represents a cross-sectional view similar to that of FIG. 1 along lines B-B, with the exception that the rigid nylon tabs of the prior art are replaced by two balls 416 and loading springs 418 that can be pushed out of the way by the treat 419 when the treat is pushed into the channel, and then rebound to engage with undercuts or indents 422 on the extruded treat. This is in contrast to the rigid tabs of the prior art which “cut through” the treat when it is pushed into the channel. The balls 416 can be positioned at the center of the toy (like the tabs in FIG. 1) and more preferably multiple balls are positioned along the length of the channel and engage the treat at multiple points along its length.

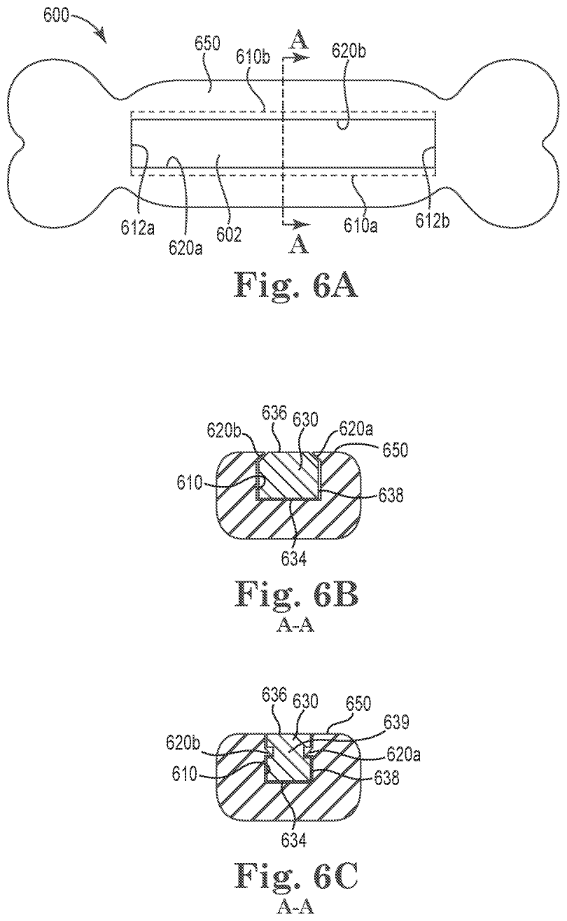

FIGS. 5A and 5B through 5D illustrate an alternative embodiment of a dog bone toy 500 that can securely contain and retain a lickable treat, with FIG. 5A being a top view of toy 500 without an inserted treat and FIG. 5B through 5D being three cross-sectional views showing a treat being inserted in toy 500.

The toy of FIGS. 5A and 5B through 5D is preferably made from a chew resistant plastic material. In FIG. 5A, toy 500 is shown having channel 502 with bendable long sides 510a and 510b, ends 512a and 512b and central portion 525. Along the long sides 510a and 510b are one or more retractable hooks 520a-f that will secure and retain treat 530 (shown in FIGS. 5B through 5D) in place. The embodiment shown in FIG. 5A is shown with six hooks 520a-f, however fewer or more hooks can be used, and the hooks do not have to be positioned directly across from each other. If desired, alternative or additional hooks (not shown) can extend along ends 512a and 512b. In FIGS. 5B-D, treat 530 with grooved sidewalls bearing grooves 532 is shown being introduced into channel 502. In FIG. 5B, sidewalls 510a and 510b are shown in their undeformed positions and hooks 520b and 520e are shown in their unretracted positions prior to the introduction of treat 530. In FIG. 5C, the treat 530 is being introduced into channel 502 and the sidewalls 510a and 510b are being bent outwardly to permit the passing of treat 530 past retracted hooks 520b and 520e. In FIG. 5D, the treat 530 has been fully introduced, the sidewalls 510a and 510b have returned to their original positions and hooks 520b and 520e have entered grooves 532 to hold and retain treat 530 in channel 502. In this embodiment the treat 530 has a lickable major surface 536 that is full width and initially flush with the surrounding portions of body 550. Hooks 520a through 520f are recessed beneath body 550 and protected from being chewed by the dog.

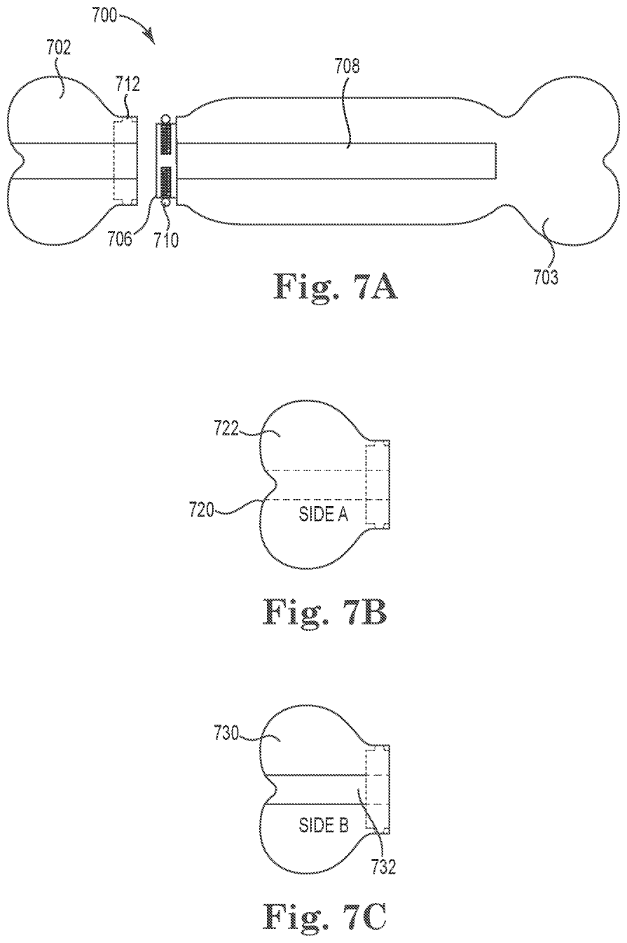

FIG. 6A-C illustrate alternative embodiments of dog bone toys that securely contain and retain a lickable treat, with FIG. 6A being a top view of the toy without its inserted treat and FIGS. 6B and 6C being alternate cross-sectional views along lines A-A of FIG. 6A and showing a treat 630 inserted in the toy.

The toys of FIGS. 6A-C are preferably made from a chew resistant, yet pliable rubber or rubbery material such as a moldable synthetic leather. In FIG. 6A, the toy 600 is shown having channel 602 with long sides 610a and 610b and ends 612a and 612b. Along the long sides 610a and 610b are one or more overhangs. The embodiment shown in FIG. 6A is shown with overhangs 620a and 620b. If desired, the overhangs can also extend along ends 612a and 612b.

In FIG. 6B, a treat 630 is shown in the channel and being held in place by overhangs 620a and 620b near the outer surface 650 of the toy 600. Top surface 636 of the treat 630 is narrower than the bottom surface 634 of the treat, thereby preventing the treat from easily being removed from the channel. As treat 630 is licked, it will tend to remain in channel 602. If desired, one or more leaf springs or other resilient devices (not shown in FIG. 6B) may be included beneath treat 630 to urge it upward against overhangs 620a and 620b.

In FIG. 6C, the treat 630 has been fully introduced into the channel and the overhangs 620a-b have returned to their original position and are shown holding the treat in the channel. In this embodiment the treat has a profile 639 along the long axis and midway between the lower 634 and upper 636 major surfaces of the treat. This permits the lickable major surface 636 of the treat to be full width at the outer surface 650 of the toy and permits the overhangs 620a-b, which are at a midpoint along wall 610, to be recessed away from the outer surface 650 and protected from being chewed by the dog. In this case treat 630 has a wide bottom 634 and sides 638 that fit tightly against the sidewalls 610 of the channel 602. The treat's sides 638 are indented at a midpoint and engage with the overhangs 620.

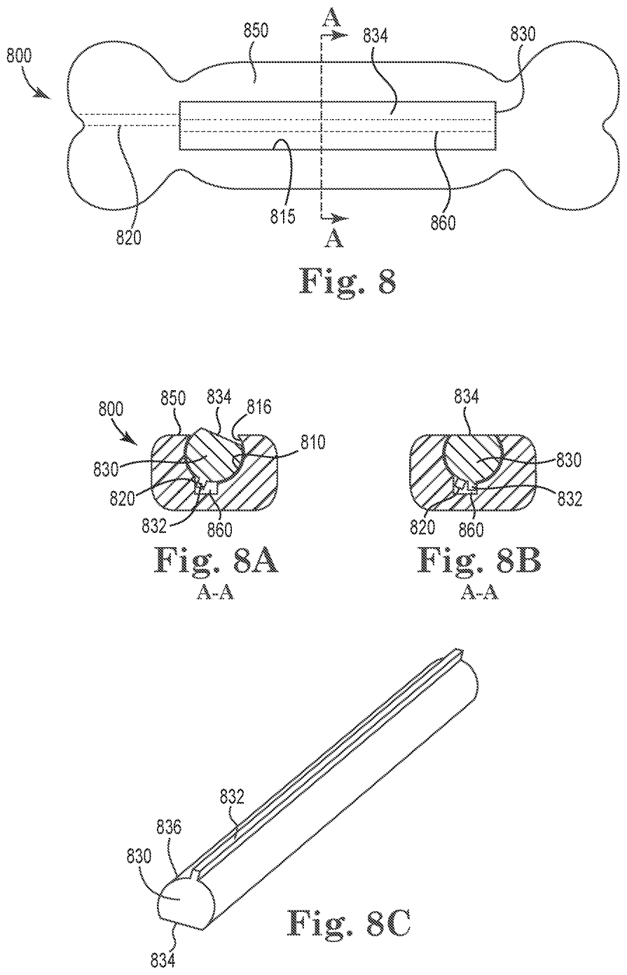

FIG. 7A illustrates a further two-piece toy 700. Knobby end 702 can be attached to the main portion 703 by inserting the small end 706 of main portion 703 into a corresponding receptacle 712 in knobby end 702. Spring loaded balls 710 can be pushed inwards while components 702 and 703 are being pushed together. The balls 710 then return to their outward position and engage recesses 712. It should be noted that either of components 702 and 703 may contain the balls and the other component may contain the recesses 712. Main portion 703 contains a channel 708 with one or more retaining devices (not shown in FIG. 7A) such as one or more hooks, a dovetail slot or overhang. A treat (not shown) can be slid into the channel from the open end when the two pieces are separated. The treat is retained in channel 708 by such retaining devices while the treat is being licked. FIG. 7B and FIG. 7C illustrate an alternative embodiment wherein knobby end 720 has smooth first side 722 and slotted second side 730. Second side 730, when oriented to align its slot 732 with the open end of channel 708 in main portion 703 will permit a treat (not shown) to be slid into channel 708. When knobby end 720 is rotated so that first side 722 closes off the end of channel 708, the treat cannot slide out of the channel.

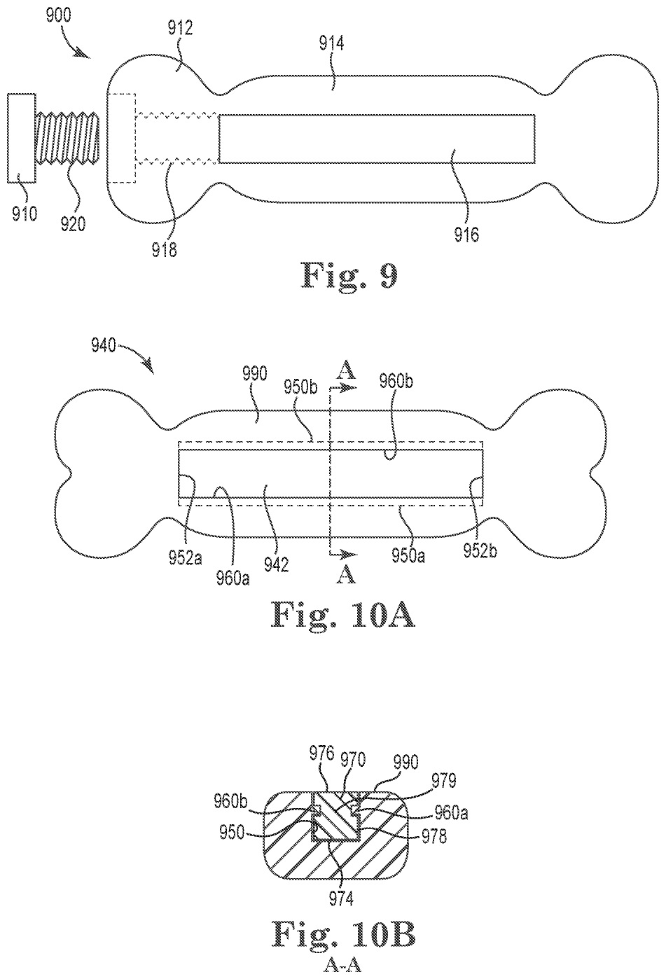

FIG. 8 and FIGS. 8A through 8C illustrate an embodiment of the toy 800. Toy 800 has an opening 815, an open end (not shown but located on the left side of toy 800 as depicted in FIG. 8), slots 820 and 860 shown in phantom, a flat lickable surface 850 and a profiled treat 830 having a lickable surface 834. Lickable surface 834 is accessed through an opening in lickable surface 850. Treat 830 (shown in perspective view in FIG. 8C) has a keyway 832 along its major axis and round sides 836. Toy 800 has corresponding round sidewalls 810 with overhangs 816. The keyway 832 and the major cross-sectional profile of treat 830 are adapted to fit into slots 820 and 860 in toy 800. FIGS. 8A and 8B are cross-sectional views along lines A-A of FIG. 8, with FIG. 8A showing treat 830 inserted at a first position through the end of toy 800 and matched to slot 820, and with FIG. 8B showing treat 830 rotated to a second position in toy 800 and slot 860 so that treat 830 cannot be easily removed through the open end of toy 800. Notably, the keyway 832 can be introduced through the open end when treat 834 is positioned as shown in FIG. 8A and guided into slots 820 and 860. Once inserted, treat 834 can be rotated to a second position as shown in FIG. 8B to thereby “lock” the treat in the toy.

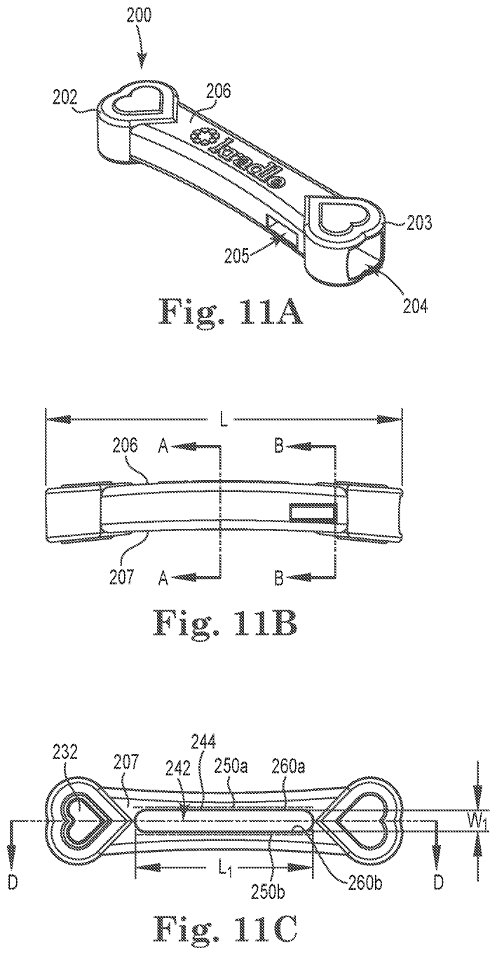

FIG. 9 illustrates a two-piece toy 900. A first major piece 914 has a channel 916 and a knobby end 912 that has a threaded opening 918 that extends from the open channel to the end of the toy. A second piece is a plug 910 that has a threaded portion 920 that can be inserted into the knobby end and thereby seal the opening.

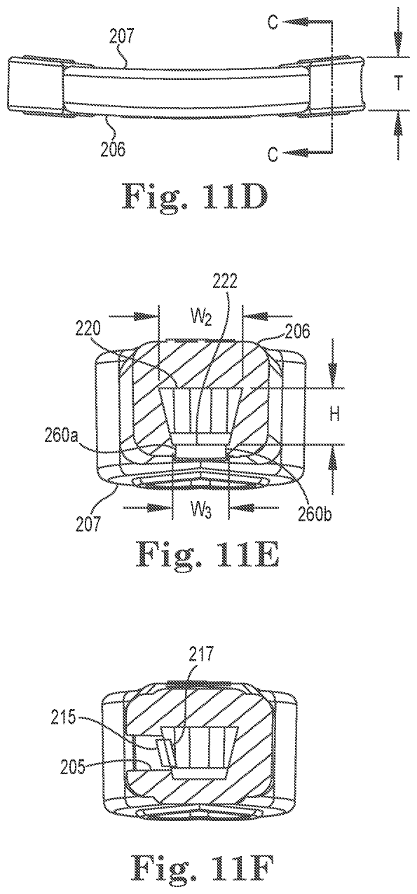

FIG. 10A-B illustrate an alternative embodiment of a dog bone toy that securely contains a lickable treat, with FIG. 10A being a top view of the toy and FIG. 10B being a cross-sectional view along lines A-A of FIG. 10A and showing a treat 970 inserted in the toy.

The toy of FIGS. 10A-B preferably is made out of a chew resistant, tough plastic material (e.g., nylon). In FIG. 10A, the toy 940 is shown having channel 942 with ends 952a and 952b and sides 950a and 950b. Along the long sides 950a and 950b are one or more overhangs. The embodiment shown in FIG. 10A is shown with overhangs 960a and 960b. If desired, the overhangs can also extend along ends 952a and 952b.

In FIG. 10B, a treat 970 is shown in the channel and being held in place by overhangs 960a and 960b near the outer surface of the toy 990. Top surface 976 of the treat 970 is narrower than the bottom surface 974 of the treat, thereby preventing the treat from easily being removed from the channel. Notably, the treat 970 of this embodiment is made of a flexible material (e.g., similar to a gummy candy), and the treat itself is able to compress and deform when it is being inserted into the channel and pushed past the overhangs. Rather than crumbling, the treat deforms to get past the overhangs and then elastically springs back to generally conform to the channel walls and engage with the overhangs.

In FIG. 10B, the treat 970 has been fully introduced into the channel and the sidewalls 950a-b have returned to their original position and are shown holding the treat in the channel. In this embodiment the treat has a profile 979 along the long axis and midway between the lower 974 and upper 976 major surfaces of the treat. This permits the lickable major surface 976 of the treat to be full width at the outer surface 990 of the toy. The sidewalls have indents 960a and 960b, which are at a midpoint along wall 950. The treat's sides 979a and 979b are outdented at a midpoint and engage with the sidewall indents 960 to hold the treat in the channel.

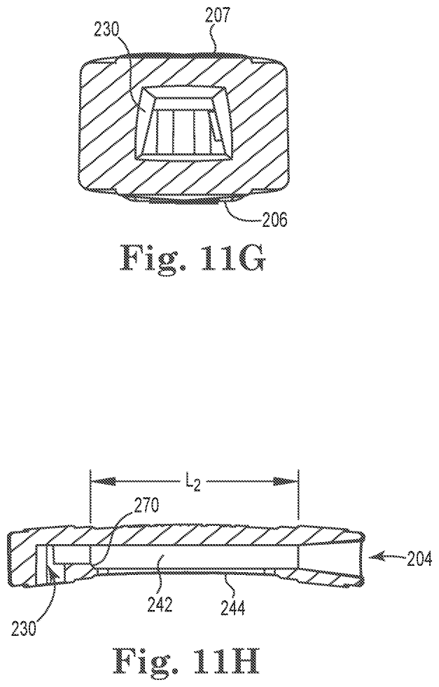

FIGS. 11A-H illustrate an alternative embodiment of a dog bone toy 200 that securely contains a lickable treat, with FIG. 11A being a perspective view of the toy, FIGS. 11B and 11D being two side views, and FIG. 11C being a bottom-side view showing a treat channel 242 accessible through opening 244. FIGS. 11E-H are respectively sectional-views along lines A-A, B-B, C-C and D-D. For clarity of the toy's features, these figures depict the toy without a treat contained therein. Toy 200 may for example be made from a chew resistant, tough plastic material (e.g., nylon). Toy 200 may for example have an overall length L (see FIG. 11B) of at least about 2, at least about 3 or at least about 4 inches, and up to about 10, up to about 8 or up to about 6 inches. Toy 200 may for example have an overall thickness T (see FIG. 11D) of at least about 0.5, at least about 0.8 or at least about 1 inches, and up to about 3, up to about 2 or up to about 1.5 inches.

In FIGS. 11A-H, toy 200 is shown having a first end 202 and a second end 203. The heart-shape of the depicted ends 202 and 203 is a decorative feature, and other decorative shapes or functional shapes (e.g., a bone end shape or a dumbbell shape) may be employed at the ends of the toy as desired. The upper central major surface 206 of toy 200 may include branding or other labeling as desired. In some embodiments, a major surface of the toy is curved (as shown for example for surface 206 in FIGS. 11B and 11D), as such curvature can enable an animal to use a paw to hold down one end of the toy and elevate the other end for ease in chewing the elevated end.

The lower central major surface or underside 207 of toy 200 includes open channel 242 through which an animal can lick (but not quickly consume) a treat held in channel 242. Second end 203 has an opening 204 for inserting a treat into channel 242. Once the treat has been inserted, tab 215 and hook 217 (depicted in FIG. 11F and residing inside opening 205) help retain the treat in place. In some embodiments the opening 204 may be tapered (see, e.g., FIG. 11G, tapered wall 230) so as to be larger in cross-sectional area at the toy's end than in channel 242. In some embodiments, the tapered opening is large enough to accept a typical human finger (e.g., an adult index finger) pushing a channel-sized treat all the way into channel 242.

In the embodiment shown in FIGS. 11C, 11E and 11F, channel 242 has a widened base 220 with a width W2 (see FIG. 11E) proximate surface 206 and a narrowed base 222 with a smaller width W₃ (see FIG. 11E) proximate surface 207 and opening 244. That is to say, channel 242 has a trapezoidal cross-sectional profile similar to the channel of FIG. 2C, though other profiles (including those shown elsewhere in this application) may be employed. Channel 242 (and the treat or treats to be inserted in channel 242) may for example have an overall length L₂ (see FIG. 1111) of at least about 1.5, at least about 2 or at least about 3 inches, and up to about 8, up to about 6 or up to about 5 inches. Channel 242 (and the treats to be inserted in channel 242) may for example have an overall height H (see FIG. 11E) of at least about 0.2, at least about 0.3 or at least about 0.4 inches, and up to about 1, up to about 0.8 or up to about 0.6 inches. Channel 242 (and the treats to be inserted in channel 242) may for example have a width W2 of at least about 0.25, at least about 0.35 or at least about 0.45 inches, and up to about 1.05, up to about 0.85 or up to about 0.65 inches. Channel 242 (and the treats to be inserted in channel 242) may for example have a width W₃ (see FIG. 11E) of at least about 0.2, at least about 0.3 or at least about 0.4 inches, and up to about 1, up to about 0.8 or up to about 0.6 inches.

Opening 244 may for example have a length L₁ (see FIG. 11C) of at least about 1, at least about 1.5 or at least about 2 inches, and up to about 6, up to about 5 or up to about 4 inches. Opening 244 may for example have a width W₁ (see FIG. 11C) of at least about 0.2, at least about 0.3 or at least about 0.4 inches, and up to about 1, up to about 0.8 or up to about 0.6 inches. As depicted in FIGS. 11C and 11E, the width W₁ of opening 244 is less than the width W₃ of opening edges 260a and 260b, and the length L₁ of opening 244 is less than the length L₂ of channel 242 and the treats that will be contained therein. In particular, edges 260a and 260b are closer together than the edges (depicted by dashed lines 250a and 250b) of base 222, thereby preventing the animal from easily removing the treat. Also, width W₁ and the proximity of edges 250a and 250b and the adjacent (and in this embodiment, tapered) channel 242 sidewalls may be adjusted to reduce or eliminate marring by animal teeth.

As shown in FIG. 11C, proximate the first end 202, toy 200 has an opening 232 to a reservoir 230 that extends to and preferably is in communication with channel 242. More preferably, the communication between the channel 242 and reservoir 230 is a narrowed passage such that a full-sized treat can be pushed to the end of treat channel 242 while stopping short of entering reservoir 230. In operation, one or more treats may be slid into channel 242 via opening 204. The treats are retained in channel 242 by hook 217 on tab 215. Tab 215, hook 217 or both are sufficiently flexible to bend out of the way while the treat is being inserted but snap back to prevent the treat from falling back out of the toy via opening 204. Moreover, as explained above the treat cannot fall out of channel 242 through opening 244. As the animal licks the treat through opening 244, the treat is slowly consumed while preferably still retaining its place inside the toy due to the narrowness of width W₁ in comparison to width W₃. Eventually, the treat is completely or nearly completely licked away by the animal. If small portions of a largely but incompletely consumed treat remain in the toy (e.g., in the bottom corners of channel 242), then the treat “dregs” can be easily removed by inserting (viz., fully introducing) a new treat into the channel. Doing so will push the dregs through the distal end of channel 242 and into reservoir 230. Any such dregs can then be easily cleaned out by the user (e.g., by shaking them from reservoir 230) or the animal can be allowed to lick or shake the dregs through opening 232.

The toy depicted in FIGS. 11A-H has been shaped so as to facilitate an animal's handling. Namely, the toy 206 has been curved in a manner such that when the channel opening is facing upwards (e.g., when the dog is licking at the treat) the convex curved surface 206 enables the animal to easily push one of the ends downward towards the floor and thereby more easily “grab” the raised other end of the toy with her paws. In preferred embodiments the toy is also tapered (see e.g., FIG. 11C) and/or the two ends are made wider than the central portion. Again, this shape facilitates the dog's holding of the toy while it is in a licking position.

A suitable drop test for assessing whether a treat is securely contained in a toy involves the following steps:

1. Hold the toy at a height of 1 meter over a concrete floor.

2. Flip the toy in a random manner and allow the toy to drop onto the concrete floor.

3. Observe whether the treat is retained in (or dislodged from) the toy.

A successful test is one where the treat is retained in the toy for all 10 drops. A drop is not a failure if only a small portion of the treat (constituting less than 5% of the treat's mass) is broken off and dislodged during this process.

### Comparison Example 1

The Prior Art device of FIG. 1 (NYLABONE) was tested as described above and also by a dog as described below. The NYLABONE toy was purchased with one included treat. Separate packs of replacement treats were also purchased. A treat was inserted into the toy's channel 24 by pressing the treat into the channel until its bottom surface rested against the channel's bottom surface. The small tabs did not deform out of the way of the treat and it was observed that the tabs would scrape against the sides of the treat. The toy with the inserted treat was provided to Ruby, an 8-month-old female Labrador dog having a shoulder height of 22 inches and weighing 60 pounds. Ruby received one treat per day for a period of five days.

On day one, Ruby used the toy by licking the treat. On day two, however, Ruby figured out that the treat could be dislodged from the toy by flipping or dropping the toy onto a carpeted floor from a height of only about 24 inches. Ruby then ate the entire treat in less than about one minute. This behavior was replicated on successive days three, four and five. On each day Ruby was able to quickly dislodge the treat with just a few short tosses.

The FIG. 1 toy was tested by holding the toy (with an inserted treat therein) at a height of 1 meter over a concrete floor. The filled toy was flipped in a random manner and allowed to drop to the concrete floor. The treat was dislodged in all ten drop tests.

### Example 1

Tests like those in Comparison Example 1 were repeated using a nylon toy molded to a shape like that shown in FIG. 11. Treats having a trapezoidal cross-section and made with a semi-hard CBD-containing formulation from the above-mentioned Application Ser. No. 63/013,158 were prepared by molding. Using an index finger, channel-length treats could easily be pushed through opening 204 and into channel 242 until the treat moved past tab 215 and hook 217 and became firmly locked into place. The toy was tested as in Comparison Example 1 by holding the toy with its inserted treat therein at a height of 1 meter over the concrete floor and flipping the treat in a random manner onto the floor. The treat was not dislodged in any of ten drop tests.

When Ruby (who by then was more than one year old) was given the treat, she tried several strategies to dislodge the treat, including flipping it into the air as she had done with the Comparison Example 1 treat. She was however unable to dislodge the treat, and instead could only consume it by licking the treat through the opening 244. Doing so was interspersed over the course of about 8 hours with chewing on the toy. The curvature of surface 206 appeared to assist such chewing, as it enabled Ruby to use a paw to hold down one end of the toy and elevate the other end so that she could more easily chew the elevated end.

Ruby's chewing caused considerable marring on the outside of the toy, but the interior components including channel 242, tab 215 and hook 217 remained pristine, unmarred, fully functional and inaccessible to Ruby's teeth. The toy appeared to be sufficiently robust to withstand dozens and potentially hundreds of all-day chewing sessions. Small dregs of the unconsumed treat were easily removed from the toy by pushing them out of channel 242 and into opening 232 using a new treat and then shaking them from opening 232.

The complete disclosure of all patents, patent applications, and publications, and electronically available material cited herein are incorporated by reference. The foregoing detailed description and examples have been given for clarity of understanding only. No unnecessary limitations are to be understood therefrom. The invention is not limited to the exact details shown and described, for variations obvious to one skilled in the art will be included within the invention defined by the claims. The invention illustratively disclosed herein suitably may be practiced, in some embodiments, in the absence of any element which is not specifically disclosed herein.

1. A dog toy, comprising:
a chew resistant body having a first end, a central portion and a second end, wherein the toy further includes
a channel along at least a portion of the central portion,
wherein the channel has a major elongated opening, and
wherein the channel is adapted to receive and securely hold and retain a replaceable lickable treat.

2. The toy of claim 1, wherein the toy is formed of two or more pieces that (i) when separated from each other (or rotated to a first position relative to each other) permit the treat to be slid into the channel through an open first end of the channel, and (ii) when connected to each other (or rotated to a second position relative to each other) effectively close the first end of the channel and prevent the treat from being slid out of the channel through the first end of the channel.

3. The toy of claim 1, wherein the toy is formed of one major piece that permits the treat to be inserted into the channel, and the channel has one or more undercuts or other retaining devices that enable retention of the treat in the toy when the toy is subjected to the “Drop Test” described herein.

4. The toy of claim 1, wherein the toy is formed of one major piece that permits the treat to be inserted into the channel, and the treat is formulated or sized to fit sufficiently snugly into the channel to enable retention of the treat in the toy when the toy is subjected to the “Drop Test” described herein.

5. The toy of claim 1, wherein the channel is adapted to receive a treat via the major elongated opening; and the chew resistant body is made of either (i) a generally rigid and tough polymer or (ii) a hard rubbery material,
wherein when the body is made of a generally rigid and tough material the channel is configured with one or more movable retaining devices that may be pushed out of the way by the treat when the treat is introduced into the channel via the major elongated opening, but which then move back when the treat is fully introduced to thereby lock the treat into place and prevent the treat from being dislodged from the toy, and
wherein when the body is made of a hard rubbery material the channel side wall is configured with one or more features that are pushed out of the way when the treat is introduced into the channel via the major elongated opening, but which then move back when the treat is fully introduced to lock the treat into place and prevent the treat from being dislodged from the toy.

6. The toy of claim 1, wherein the toy is constructed of a generally rigid and tough polymer and includes one or more retaining devices comprising a molded tab or hook that can bend out of the way during insertion of the treat into the channel.

7. The toy of claim 1, wherein the toy is made from an injection moldable nylon material.

8. The toy of claim 1, wherein the toy is made from a chew resistant rubbery material.

9. The toy of claim 1, wherein the toy further comprises a reservoir comprising a narrowed passage positioned so that the treat can be fully introduced into the channel but stops short of entering the reservoir.

10. The toy of claim 9, wherein dregs of largely but incompletely consumed treats are pushed into the reservoir when a further treat is fully introduced into the channel.

11. The toy of claim 1, wherein the toy has a curved major surface that enables an animal to use a paw to hold down the first end and elevate the second end to facilitate chewing on the elevated second end.

12. The toy of claim 1, wherein the toy further comprises a treat.

13. The toy of claim 1, wherein the treat contains an active ingredient.

14. The toy of claim 1, wherein the active ingredients include two or more active agents selected from the group consisting of theanine, Relora, SAMe, GABA, ashwagandha, tryptophan, turmeric, Boswellia serrata, ginseng, Methylsulfonylmethane, 5-HTP, Valerian root, Chamomile, Lemon balm, Passion flower, Kavakava, and Ocimum tenuiflorum.

15. The toy of claim 1, wherein the active ingredients include one or more pharmacologically active, but non-psychoactive, cannabinoids.

16. The toy of claim 1, wherein the toy is packaged with one or more treats selected from a set of treats dosed with active ingredients appropriate for a small or a medium or a large dog.

17. The toy of claim 16, wherein the toy contains CBD and the CBD is present in an amount between 2 and 30 mg per 17.2 kg of body size.

18. An elongated dog treat containing an active ingredient, wherein
the treat has a first major elongated lickable surface that resists premature degradation or breaking up when licked repeatedly by a dog,
the treat has a profile along its two major side surfaces that are adapted to engage with corresponding features along the sidewalls of an elongated channel on a dog toy,
wherein the first major lickable surface of the treat is available for being licked by a dog when the treat is being held by the dog toy.

19. A chew resistant article that securely contains and retains a replaceable lickable treat, wherein the article facilitates the predictable, gradual, and prolonged ingestion of the treat by an animal's licking of an available surface of the treat.

20. A method of calming a dog, comprising the steps of:
providing a bolus dose of an active ingredient and
providing a calming occupying toy containing an additional dose of such active ingredient in a replaceable, lickable treat, wherein the toy contains and retains the treat such that a substantial portion of the treat must be consumed by the animal by licking the treat.
